(19) United States
(12) Patent Application Publication
(10) Pub. No.: US 2021/0365959 A1
(43) Pub. Date: Nov. 25, 2021

(54) METHOD FOR PROVIDING GOAL ACHIEVEMENT REWARD

(71) Applicant: Whitecube Inc, Seoul (KR)

(72) Inventor: Hyuk Joon CHOI, Seoul (KR)

(73) Assignee: Whitecube Inc, Seoul (KR)

(21) Appl. No.: 17/328,627

(22) Filed: May 24, 2021

(30) Foreign Application Priority Data
May 25, 2020 (KR) 10-2020-0062661
Jul. 7, 2020 (KR) 10-2020-0083634

(51) Int. Cl. G06Q 30/02; G06K 9/62; G06F 21/31

(52) U.S. Cl. CPC G06Q 30/02; G06F 21/31; G06K 9/6215; G06K 9/6202

(57) ABSTRACT

A method for providing a goal achievement reward, which is performed by one or more processors, is provided. The method includes receiving, from a user terminal, a request to participate in a challenge, receiving, from the user terminal, a request to pay a participation fee for the challenge, receiving, from the user terminal, a plurality of images associated with the challenge, calculating a percentage of challenge achievement of a first user account associated with the user terminal based on the plurality of images, and providing a reward to the user terminal based on the calculated percentage of challenge achievement.

### CROSS-REFERENCE TO RELATED APPLICATION

This application claims priority under 35 U.S.C. § 119 to Korean Patent Application No. 10-2020-0062661, filed in the Korean Intellectual Property Office on May 25, 2020 and Korean Patent Application No. 10-2020-0083634, filed in the Korean Intellectual Property Office on Jul. 7, 2020, the entire contents of which are hereby incorporated by reference.

### TECHNICAL FIELD

The present disclosure relates to a method for providing a goal achievement reward, and more particularly, to a method for providing a reward according to a percentage of achievement of a challenge that a user is participating, when the user achieves a goal of the challenge that the user is participating.

### BACKGROUND ART

In general, people set new goals each year or each month to improve themselves, and put a lot of effort into achieving the goals. However, after a certain period of time, most people experience a situation where they cannot achieve their goals due to various reasons and give up on the challenge in the middle. The difficulty level of the goals set by people varies from person to person, and as the difficulty of the goal increases, the degree of achievement increases accordingly, but the effort required to achieve the goal also increases, resulting in a problem that more people give up in the middle of a challenge.

People set his own goals and try to change his minds, such as reading self-development books, watching motivational videos, going to the gym, buying magazines, and so on. Accordingly, online self-development applications without time and space constraints are widely used. However, traditional self-development applications have limitations in changing behavior and patience is required to achieve goals set by users. In addition, since the user sets a goal by himself and acts to tackle the goal, there is a problem that it is difficult to continue for a long time without receiving a separate reward.

### SUMMARY

The embodiments disclosed in the present disclosure may provide a method for providing a reward according to a percentage of achievement of a challenge that a user is participating, when the user achieves a goal of the challenge that the user is participating.

Embodiments disclosed in the present disclosure provide a method capable of determining whether or not authentication of achievement of a goal of a challenge that a user is participating is forged.

A method for providing a goal achievement reward is provided, which may be performed by one or more processors and include receiving, from a user terminal, a request to participate in a challenge, receiving, from the user terminal, a request to pay a participation fee for the challenge, receiving, from the user terminal, a plurality of images associated with the challenge, calculating a percentage of challenge achievement of a first user account associated with the user terminal based on the plurality of images, and providing a reward to the user terminal based on the calculated percentage of challenge achievement.

According to an embodiment, the providing a reward to the user terminal may include in response to determining that the percentage of challenge achievement is 100%, providing the participation fee and additional prize money to the user terminal as a reward, in response to determining that the percentage of challenge achievement is equal to or greater than a preset threshold value and less than 100%, providing the challenge participation fee to the user terminal as a reward, and in response to determining that the percentage of challenge achievement is less than a preset threshold value, providing a portion of the challenge participation fee to the user terminal as a reward in which the additional prize money may be determined based on non-refundable amounts of user accounts having a percentage of challenge achievement less than the preset threshold value, among a plurality of other user accounts participating in the challenge.

According to an embodiment, the method may further include receiving identification information of the user terminal, storing the identification information of the user terminal in association with the first user account, and in response to detecting an attempt to access using a second user account from the user terminal, transmitting a warning message to the user terminal.

According to an embodiment, the plurality of images may include a first image, and the calculating a percentage of challenge achievement may include determining an object associated with the challenge based on a name of the challenge, determining whether the object associated with the challenge is included in the first image using an object recognition model, and in response to determining that the object associated with the challenge is included in the first image, recognizing the first image as an authentication image.

According to an embodiment, the plurality of images may include a first image and a second image including the object associated with the challenge, and the calculating a percentage of challenge achievement may include in response to receiving the second image after a predetermined period of time elapses from a time of receiving the first image, recognizing the first image as an authentication image.

According to an embodiment, the plurality of images may include a first image, and the calculating a percentage of challenge achievement may include in response to determining that position information associated with the first image has a difference equal to or greater than a predetermined threshold value from position information associated with pre-authenticated authentication images among the plurality of images, denying authentication of the first image.

According to an embodiment, the plurality of images may include a first image, and the calculating a percentage of challenge achievement may include comparing image quality between the first image and pre-authenticated authentication images among the plurality of images, and in response to determining that the first image has an image quality difference equal to or greater than a predetermined threshold value from the pre-authenticated authentication images, denying authentication of the first image.

According to an embodiment, the plurality of images may include a first image, and the calculating a percentage of challenge achievement may include calculating a similarity between the first image and pre-authenticated authentication images of other user accounts participating in the challenge, and in response to determining that, among the pre-authenticated authentication images of the other user accounts, there is an authentication image having a similarity equal to or greater than a predetermined threshold value to the first image, denying authentication of the first image.

According to an embodiment, the method may further include: transmitting, to the user terminal, the authentication image of another user account having a similarity equal to or greater than the predetermined threshold value to the first image, and transmitting, to the user terminal, a message to change an image capturing angle and capture the first image again by referring to the authentication image of the other user account.

According to an embodiment, the plurality of images may include a first image, and the calculating a percentage of challenge achievement may include transmitting, to the user terminal, a request for a user input after a predetermined time elapses from a time of receiving the first image, and in response to receiving, from the user terminal, a response to the request for a user input within a predetermined deadline, recognizing the first image as an authentication image.

According to various embodiments of the present disclosure, it is possible that the user directly sets the participation fee for the challenge that he is participating and that the reward is provided according to the percentage of achievement, which can provide motivation to the user and allow the user to manage his goals independently. In addition, a plurality of users may participate in a challenge together, which can induce a good-willed competition and raise a sense of goal.

According to various embodiments of the present disclosure, in response to the received request to authenticate performance of a challenge, it may be automatically determined whether or not the user performed the challenge, which can reduce the hassle of the administrator or participants of having to individually determine whether or not a challenge has been performed. In addition, a transparent providing of a reward may be enabled by preventing illegal acts such as forgery of images, the use of multiple accounts, and the like.

According to various embodiments of the present disclosure, when access is attempted with a user account other than the user account associated with the user terminal, the goal achievement reward providing service may not be accessible or only the inquiry service may be allowed, so that it is possible to prevent a single user from repeatedly participating in the same challenge using a plurality of user accounts and receiving additional prize money redundantly.

The effects of the present disclosure are not limited to the effects described above, and other effects that are not mentioned above can be clearly understood to those skilled in the art based on the description provided below.

### BRIEF DESCRIPTION OF THE DRAWINGS

Embodiments of the present disclosure will be described with reference to the accompanying drawings described below, where similar reference numerals indicate similar elements, but embodiments are not limited thereto, in which:

FIG. 1 is a diagram illustrating an example in which a user 110 uses a user terminal 120 to capture an image associated with a challenge that the user is participating, and receives a reward upon completion of authentication according to an embodiment;

FIG. 2 is a schematic diagram illustrating an environment for providing a goal achievement reward providing service using a goal achievement reward providing system according to an embodiment;

FIG. 3 is a block diagram illustrating an internal configuration of the goal achievement reward providing system according to an embodiment;

FIG. 4 is a diagram illustrating an example of generating a request to participate in a challenge and a request to pay a participation fee according to an embodiment;

FIG. 5 is a flowchart illustrating a method for preventing a single user from receiving rewards redundantly using a plurality of user accounts according to an embodiment;

FIG. 6 is a diagram illustrating an example of determining whether or not a user performed a challenge, by determining whether or not an object associated with the challenge is included in an image according to an embodiment;

FIG. 7 is a diagram illustrating an example of authenticating performance of a challenge according to an embodiment;

FIG. 8 is a diagram illustrating an example of determining whether or not a challenge has been performed based on position information according to an embodiment;

FIG. 9 is a diagram illustrating an example of determining whether or not a challenge has been performed according to an image quality of an image according to an embodiment;

FIG. 10 is a flowchart illustrating a method for determining whether or not a challenge has been performed based on a similarity to authentication images of other users according to an embodiment;

FIG. 11 is a flowchart illustrating a method for authenticating whether or not a challenge specialized for a wake-up mission was performed according to an embodiment; and

FIG. 12 is a structural diagram illustrating an artificial neural network according to an embodiment.

### DETAILED DESCRIPTION OF THE INVENTION

Hereinafter, specific details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding elements are assigned the same reference numerals. In addition, in the following description of the embodiments, duplicate descriptions of the same or corresponding components may be omitted. However, even if descriptions of components are omitted, it is not intended that such components are not included in any embodiment.

Advantages and features of the disclosed embodiments and methods of accomplishing the same will be apparent by referring to embodiments described below in connection with the accompanying drawings. However, the present disclosure is not limited to the embodiments disclosed below, and may be implemented in various different forms, and the present embodiments are merely provided to make the present disclosure complete, and to fully disclose the scope of the invention to those skilled in the art to which the present disclosure pertains.

The terms used herein will be briefly described prior to describing the disclosed embodiments in detail. The terms used herein have been selected as general terms which are widely used at present in consideration of the functions of the present disclosure, and this may be altered according to the intent of an operator skilled in the art, conventional practice, or introduction of new technology. In addition, in a specific case, a term is arbitrarily selected by the applicant, and the meaning of the term will be described in detail in a corresponding description of the embodiments. Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it intends to mean that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to reproduce one or more processors. Accordingly, as an example, the “module” or “unit” may include components such as software components, object-oriented software components, class components, and task components, and at least one of processes, functions, attributes, procedures, subroutines, program code segments of program code, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

According to an embodiment of the present disclosure, the “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination of processing devices, e.g., a combination of a DSP and a microprocessor, a plurality of microprocessors, one or more microprocessors in conjunction with a DSP core, or any other combination of such configurations. In addition, the “memory” should be interpreted broadly to encompass any electronic component capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with a processor is in electronic communication with the processor.

In the present disclosure, the statement “A and/or B” means A, or B, or A and B.

In the present disclosure, a “challenge” may refer to a goal that a user wants to achieve. For example, it could be drinking water 3 times a day, studying for 1 hour a day, walking 10,000 steps 3 or more days a week, looking at the sky once a day, weighing every day, and so on.

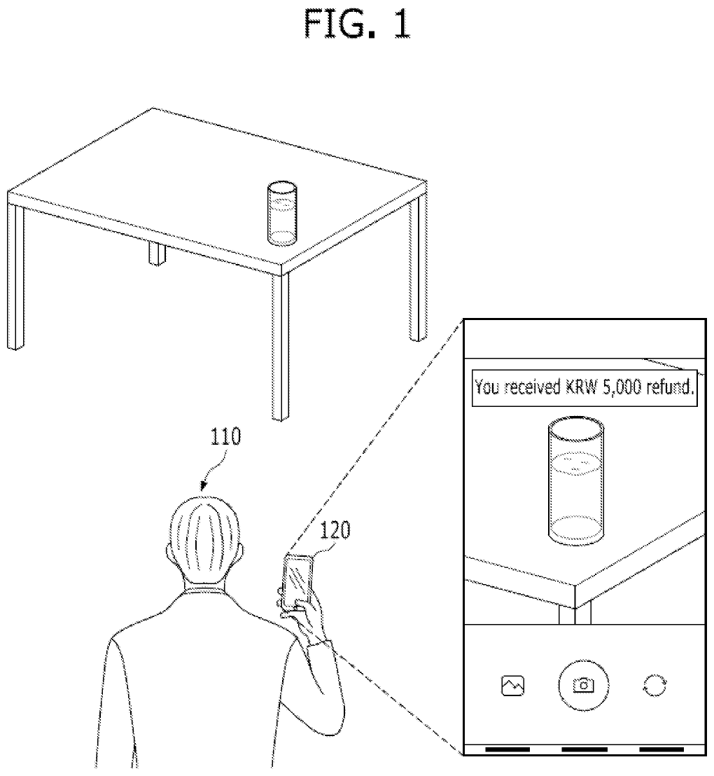

FIG. 1 is a diagram illustrating an example in which a user 110 uses a user terminal 120 to capture an image associated with a challenge that the user is participating, and receives a reward upon completion of authentication according to an embodiment. A user 110 may use a user terminal 120 to use a goal achievement reward providing service. According to an embodiment, the user 110 may select at least one of a plurality of challenges opened through an application running on the user terminal 120, and pay a participation fee for the selected challenge to use the goal achievement reward providing service. For example, the user 110 may participate in a challenge of “Drink water once a day for a week” and pay 70,000 Korean won (KRW) as a participation fee. In this case, the user 110 may directly set the participation fee for the challenge by himself or may pay a preset participation fee.

According to an embodiment, the user 110 may capture, through the user terminal 120, an image associated with the challenge that he is participating in order to achieve the challenge that he is participating. For example, when the challenge that the user 110 is participating is “Drink water once a day for a week”, the user 110 may capture an image associated with the challenge of “Drink water once a day for a week” through an in-app camera of an application running on the user terminal 120. As illustrated, the user 110 may capture an image associated with the challenge by capturing an image of a water glass (or a water bottle, and the like) placed on a desk to authenticate that the user drank water on that date.

The user 110 may provide a reward, based on the image associated with the challenge captured using the user terminal 120 and calculation of a percentage of achievement of a challenge. For example, when the user 110 sets and pays the participation fee for the challenge of “Drink water once a day for a week” as “KRW 35,000”, when the image associated with the challenge is captured once and authentication is completed, the user 110 may be provided with “KRW 5000”, which is 1/7 of the participation fee, as illustrated. In addition, after the challenge is completed, the user may be provided with the additional prize money when the percentage of achievement of a challenge meets a predetermined condition. In another embodiment, instead of being provided with a portion of the participation fee each time it is authenticated that the challenge was performed, it is possible that a portion or all of the participation fee and an additional reward are provided at once after completion of the challenge period, based on the cost of achievement of challenge. In this way, the user 110 may be allowed to directly set the participation fee for the challenge that he is participating and provided with the reward according to the percentage of achievement of a challenge, which may provide motivation to the user 110 and allow the user to manage his goals independently.

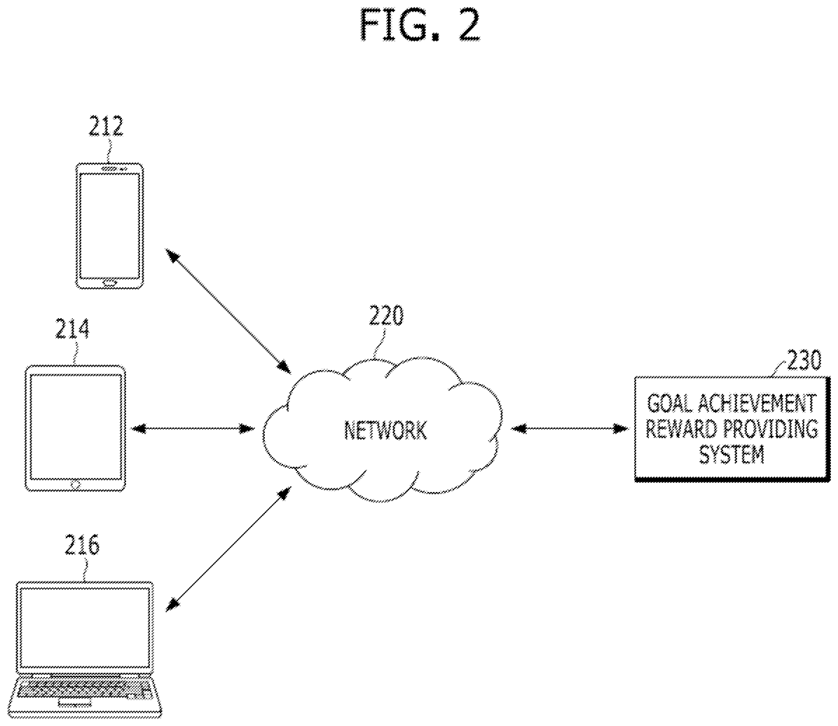

FIG. 2 is a schematic diagram illustrating an environment for providing a goal achievement reward providing service using a goal achievement reward providing system 230 according to an embodiment. The goal achievement reward providing system 230 may provide the goal achievement reward providing service to a plurality of user terminals 212, 214, and 216 through a network 220. According to an embodiment, the goal achievement reward providing system 230 may include one or more server devices and/or databases capable of storing, providing and executing computer-executable programs (e.g., downloadable applications) and data associated with the goal achievement reward providing service, or one or more distributed computing devices and/or distributed databases based on cloud computing services. In this example, the goal achievement reward providing service provided by the goal achievement reward providing system 230 may be provided to the user through a dedicated application installed on the plurality of user terminals 212, 214, and 216, a web browser, or the like.

The plurality of user terminals 212, 214, and 216 may communicate with the goal achievement reward providing system 230 through the network 220. The network 220 may be configured to enable communication between the plurality of user terminals 212, 214, and 216 and the goal achievement reward providing system 230. The network 220 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment.

In FIG. 2, the mobile phone terminal 212, the tablet terminal 214, and the PC terminal 216 are illustrated as examples of user terminals, but embodiments are not limited thereto, and the user terminal may be any computing device that is capable of wired and/or wireless communication and that has a user interface (e.g., touch display, keyboard, mouse, touch pen or stylus, microphone, motion sensor) capable of accessing the goal achievement reward providing system. For example, the user terminal may include a smart phone, a mobile phone, a navigation system, a computer, a notebook computer, a digital broadcasting terminal, a personal digital assistant (PDA), a portable multimedia player (PMP), a tablet PC, a game console, a wearable device, an internet of things (IoT) device, a virtual reality (VR) device, an augmented reality (AR) device, and the like. In addition, while FIG. 2 shows that three user terminals 212, 214, and 216 communicate with the goal achievement reward providing system 230 through the network 220, embodiments are not limited thereto, and a different number of user terminals may be configured to communicate with the goal achievement reward providing system 230 through the network 220.

The communication method between the user terminals 212, 214, and 216 and the goal achievement reward providing system 230 is not limited, and may include not only a communication method using a communication network (e.g., mobile communication network, wired Internet, wireless Internet, broadcasting network, satellite network, and the like) that may be included in the network 220 as well as short-range wireless communication between user terminals. For example, the network 220 may include any one or more of networks including a personal area network (PAN), a local area network (LAN), a campus area network (CAN), a metropolitan area network (MAN), a wide area network (WAN), a broadband network (BBN), the Internet, and the like. In addition, the network 220 may include any one or more of network topologies including a bus network, a star network, a ring network, a mesh network, a star-bus network, a tree or hierarchical network, and the like, but not limited thereto.

The goal achievement reward providing system 230 may receive a request to create a challenge from the user terminals 212, 214, and 216 through the network 220. The received request to create a challenge may be stored as challenge information in the goal achievement reward providing system 230. The request to create a challenge may include information on the user who generated the request to create a challenge, information on a goal that the user wants to achieve (e.g., challenge name, a period of time for performing the challenge, the number of days to perform the challenge, and the like). For example, when a user aiming for a regular walking requests to create a challenge by inputting information (e.g., challenge name: walking 10,000 steps, period of time for performing the challenge: June, number of days to perform the challenge: 3 times a week) on a goal that the user wants to achieve using the user terminal, the goal achievement reward providing system 230 may create a challenge based on the received request to create a challenge. Additionally, the user may set in advance a participation fee of the challenge to be created through the user terminal to request a creation of a challenge.

In an embodiment, the goal achievement reward providing system 230 may receive a request to participate in one of a plurality of challenges created from the user terminal 212, 214, and 216. In this example, the request to participate may include information on a selected challenge, such as a period of time for performing the challenge, a day of the week when authentication of the challenge is available, a time when authentication is available, a frequency of authentication, and the like. In another embodiment, the request to participate may include information on the participation fee desired by the user. In this case, the goal achievement reward providing system 230 may provide the user terminals 212, 214, and 216 with an interface for requesting a payment for the participation fee for the selected challenge.

The goal achievement reward providing system 230 may receive a request to pay the participation fee from the user terminals 212, 214, and 216 through the network 220. The goal achievement reward providing system 230 may process the payment of the participation fee for the challenge in response to the received request to pay so that the user can participate in the challenge. The participation fee for the challenge may be directly set by the user himself through an interface provided to the user terminal, or the participation fee for the challenge may be preset and provided to the user.

The goal achievement reward providing system 230 may receive, through the network 220, a request to authenticate performance of a challenge from the user terminals 212, 214, and 216 participating in the challenge. According to an embodiment, the request to authenticate performance of a challenge may include image(s) captured using the cameras of the user terminals 212, 214, and 216. The goal achievement reward providing system 230 may automatically determine whether or not the user performed the challenge on that date based on the received image(s). For example, the goal achievement reward providing system 230 may analyze the image(s) included in the request to authenticate performance of a challenge to automatically determine whether or not the image is forged, whether or not the challenge is performed, and the like.

When the goal achievement reward providing system 230 determines that the user has performed the challenge on that date, the received image(s) may be stored as an authentication image. In addition, when the user performs the challenge on that date, the goal achievement reward providing system 230 may provide a predetermined amount (e.g., participation fee divided by the number of days to perform the challenge) to the user (or the user account, the user terminal). When the predetermined period of time for performing the challenge is completed, the goal achievement reward providing system 230 may provide the user (or the user account, the user terminal) a reward based on the percentage of achievement of a challenge of the user.

In this way, the goal achievement reward providing system 230 may directly set the participation fee for the challenge that the user is participating and provide the reward according to the percentage of achievement, to thus provide motivation to the user and allow the user to manage his goals independently. In addition, a plurality of users may participate in a challenge together, which can induce a good-willed competition and raise a sense of goal. Additionally, in response to the received request to authenticate performance of a challenge, it may be automatically determined whether or not the user performed the challenge, which can reduce the hassle of the administrator or participants of having to individually determine whether or not a challenge has been performed. In addition, a transparent providing of a reward may be enabled by preventing illegal acts such as forgery of images, the use of multiple accounts, and the like.

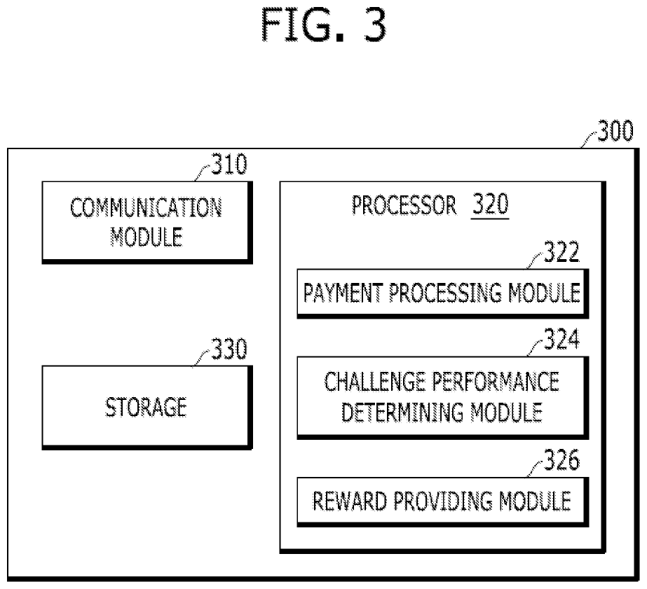

FIG. 3 is a block diagram illustrating an internal configuration of the goal achievement reward providing system 300 according to an embodiment. As illustrated in FIG. 3, the goal achievement reward providing system 300 may include a communication module 310, a processor 320, and a storage 330. The processor 320 may include a payment processing module 322, a challenge performance determining module 324, and a reward providing module 326. FIG. 3 illustrates that the processor 320 includes a plurality of sub-modules, but is not limited thereto, and it may be configured as an integrated processor. In addition, the processor 320 may be configured with a plurality of processors.

The communication module 310 may be configured to enable the goal achievement reward providing system 300 to transmit and receive any information or data to and from a plurality of user terminals through a network. The processor 320 may be configured to receive requests from a plurality of user terminals through the communication module 310 and process the same. The storage 330 may be configured to store the information and data received from the user terminal and store information generated by the processor 320.

In an embodiment, the communication module 310 may receive a request to create a challenge from the user terminal and transmit the same to the processor 320. The request to create a challenge may include information on the user who generated the request to create a challenge and detailed information on the challenge. For example, the user information may include user-related information, such as a user account, user personal information, and the like, and the detailed information on the challenge may include various information related to the challenge, such as the name of the challenge, the period of time for performing the challenge, the number of days to perform the challenge, the time to perform the challenge, the participation fee, or the like.

The communication module 310 may receive a request to participate in a challenge from the user terminal and transmit the same to the processor 320. In this example, the request to participate may include a user account, information on a challenge to participate (e.g., a challenge identifier, and the like), a participation fee, and the like. After receiving the request to participate in a challenge, the processor 320 may receive a request to pay a challenge participation fee from the user terminal through the communication module 310. The payment processing module 322 of the processor 320 may process payment according to the received request to pay and store the processing result in the storage 330 as payment information. The request to pay a challenge participation fee may include information (a user account, and the like) on a user who generated the request, information on the challenge to participate (a challenge identifier, and the like), a participation fee, information on a payment method, and the like.

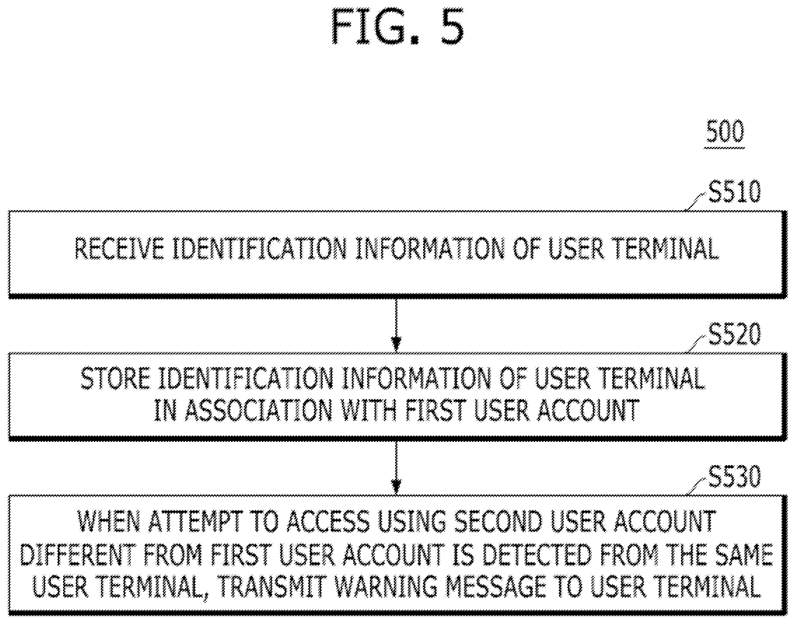

During the period of time to perform the challenge that the user is participating, the user may capture an image associated with the challenge that the user is participating through the user terminal, and request the goal achievement reward providing system 300 to authenticate performance of a challenge at a specific date. The challenge performance determining module 324 may be configured to automatically determine whether or not a challenge has been performed based on the request to authenticate performance of a challenge received through the communication module 310. In this example, the request to authenticate performance of a challenge may include user information, time information, at least one image, and the like. The process at the challenge performance determining module 324 of automatically determining whether or not a challenge has been performed will be described in detail below with reference to FIGS. 5 to 12.

The reward providing module 326 may be configured to calculate a percentage of achievement of a challenge of a user account associated with the user terminal, based on the number of times of authenticating performance of a challenge, a total number of days of a challenge, and the like which may be recognized by the challenge performance determining module 324. According to an embodiment, the reward providing module 326 may calculate a percentage of achievement of a challenge based on the number of times of authenticating performance of a challenge/a total number of times to perform a challenge. For example, when the total number of times the user has to perform a challenge during the period of time for performing the challenge is 10 times, and the number of times of authenticating performance of a challenge is 5 times, the reward providing module 326 may calculate the percentage of achievement of a challenge of the user as 50%.

In addition, the reward providing module 326 may be configured to provide a reward to the user terminal based on the calculated percentage of achievement of a challenge. According to an embodiment, when the percentage of achievement of a challenge is 100%, the reward providing module 326 may provide the challenge participation fee and additional prize money as a reward to the user terminal, and when the percentage of achievement of a challenge is equal to or greater than a preset threshold value (e.g., the percentage of achievement of a challenge is 80%) and less than 100%, the reward providing module 326 may provide the challenge participation fee to the user terminal as a reward. For example, when the participation fee paid by the user to participate in the challenge is “KRW 10,000”, and the user's percentage of achievement of a challenge is 100%, the participation fee “KRW 10,000” and additional prize money are provided, and when the user's percentage of achievement of a challenge is 80%, only the participation fee “KRW 10,000” may be provided.

Meanwhile, when the percentage of achievement of a challenge is less than a preset threshold value (e.g., 80%), the reward providing module 326 may provide only a portion of the challenge participation fee to the user terminal as a reward. In this case, the reward may be determined based on the percentage of achievement of a challenge and the participation fee. For example, when the user's percentage of achievement of a challenge is 10%, the reward providing module 326 may provide “KRW 1,000”, which is 1/10 of the participation fee “KRW 10,000” paid by the user, as a reward. At this time, “KRW 9,000”, which is the non-refundable amount of the participation fee paid by the user, may be provided, as the additional prize money, to another user account(s) that achieved a predetermined condition (e.g., 100% percentage of achievement of a challenge) among a plurality of other user accounts participating in the selected challenge. For example, when there is one user with a 100% percentage of achievement of a challenge, this user may receive the non-refundable amount (e.g., KRW 9,000) in full as the additional prize money, and when there are two users with a 100% percentage of achievement of a challenge, these two users may share the non-refundable amount equally.

That is, the additional prize money provided to the users with the percentage of achievement of a challenge equal to or greater than a predetermined condition (e.g., 100%) may be determined based on the non-refundable amount of the user accounts with the percentage of achievement less than the preset threshold value (e.g., 80%) among a plurality of other user accounts participating in the selected challenge. According to an embodiment, the reward providing module 326 may provide, as the additional prize money, an amount obtained by dividing the total amount of non-refundable amounts of the user accounts with the percentage of achievement less than the preset threshold value among the plurality of user accounts participating in the challenge, by the number of user accounts with the percentage of achievement of a challenge equal to or greater than the predetermined condition among a plurality of user accounts participating in the challenge, to each user account with the percentage of achievement of a challenge equal to or greater than the predetermined condition.

In an embodiment, the reward providing module 326 may provide the reward and the additional prize money to the users at once, after the period of time for performing a challenge ends. In another embodiment, the reward providing module 326 may provide a reward each time it is authenticated that the users performed a challenge of a specific date, and provide the additional prize money to the users after the period of time for performing a challenge ends.

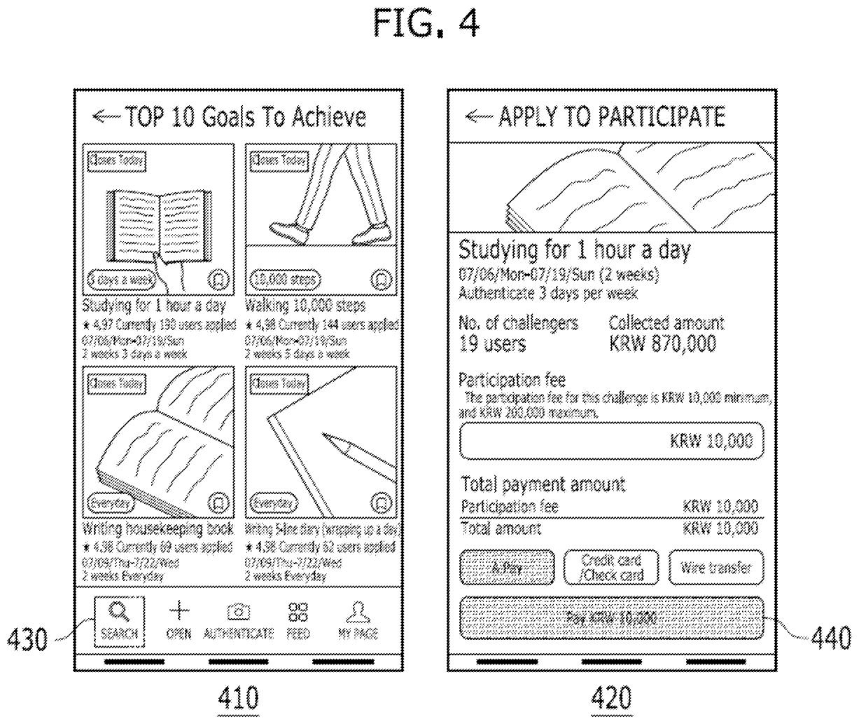

FIG. 4 is a diagram illustrating an example of generating a request to participate in a challenge and a request to pay a participation fee according to an embodiment. The user may use an application or a web browser running on the user terminal to participate in the challenge, through a first operation 410 and a second operation 420. The first operation 410 represents the user selecting one challenge to participate, from a challenge list that includes a plurality of challenges. In the challenge list, a name (e.g., “Study 1 hour a day”), a rating (e.g. 4.97), the current number of participants (e.g. 190 people), a period of time for performing a challenge (e.g. July 6/Mon-July/19/Sun 2 weeks), the number of days to perform the challenge (3 days a week), a related image, information on participation deadline, and the like of each challenge may be displayed.

According to an embodiment, the user may select a challenge search button 430 to search for a desired challenge to participate. In this case, the challenge list may be displayed on a screen and provided to the user. For example, the challenge list may be sorted in order with the earliest deadline for participating in the challenge and provided to the user. The user may select one of the challenges displayed on the screen through a touch input and the like to move to a screen on which the participation fee for the challenge can be paid. In another embodiment, it is also possible that the user directly opens a challenge when the desired challenge is not found.

The second operation 420 represents that a screen for a request to pay a challenge participation fee is displayed on a display of the user terminal, in response to the user selecting one challenge (e.g., “Study 1 hour a day” challenge) from the challenge list. The screen for a request to pay a challenge participation fee may include the name (“Study 1 hour a day”) of the challenge selected by the user, the number of challengers (19 challengers) participating in the challenge, the amount (KRW 870,000) collected through the challenge, an interface for inputting the user's participation fee, a guide for the participation fee (“The participation fee for this challenge is at least KRW 10,000, and maximum KRW 200,000.”), and an interface for inputting information on a payment method. As illustrated, the user may input information on the participation fee and payment method through a touch input, a typing input, and the like. For example, the user may select “KRW 10,000” as a challenge participation fee and “A Pay” as a payment method. Then, the user may select a payment request button 440 through a touch input, or the like, and transmit a request to participate in a challenge and a request to pay a participation fee to the goal achievement reward providing system. The user may then participate in the selected challenge by completing the payment through a payment page displayed on the display of the user terminal.

FIG. 5 is a flowchart illustrating a method 500 for preventing a single user from receiving rewards redundantly using a plurality of user accounts according to an embodiment. The method 500 may be performed by the goal achievement reward providing system (e.g., one or more processors of the goal achievement reward providing system). As illustrated, the method 500 may be initiated at S510 of, by the processor, receiving identification information of the user terminal from the user terminal that logged in with a first user account to an application that provides a goal achievement reward providing service. For example, the identification information of the user terminal is unique information for identifying the user terminal, and may include International Mobile Equipment Identity (IMEI), Mac address, IP address, device serial number, phone number, ESN information, and the like.

Then, at S520, the processor may store the received identification information of the user terminal and the first user account in association with each other. According to an embodiment, the first time when the user accesses the application that provides the goal achievement reward providing service through the user terminal, an interface for creating a user account may be provided to the user terminal to request to create a user account. When a user account is generated according to the input by the user, the identification information of the user terminal and the generated user account may be matched and stored in the storage.

Thereafter, when an attempt to access using a second user account different from the first user account is detected from the same user terminal, the operation at S530 of transmitting a warning message to the user terminal may be performed. For example, the warning message may be a message indicating that a login with two or more user accounts using one user terminal is not permitted. According to an embodiment, it may be determined whether or not the user account attempting to access through the user terminal is the same as the user account stored in association with the user terminal in the storage. When the user account attempting to access through the user terminal matches the user account previously stored in the storage, access to the goal achievement reward providing service may be allowed, and when the user account attempting to access through the user terminal does not match the user account previously stored in the storage, a warning message may be transmitted to the user terminal. In this way, when access is attempted with a user account other than the user account associated with the user terminal, the goal achievement reward providing service may not be accessible or only the inquiry service may be allowed, so that it is possible to prevent a single user from repeatedly participating in the same challenge using a plurality of user accounts and receiving additional prize money redundantly. In another embodiment, the processor may allow access and login with different user accounts using the same user terminal, but restrict the user accounts from participating in the same challenge.

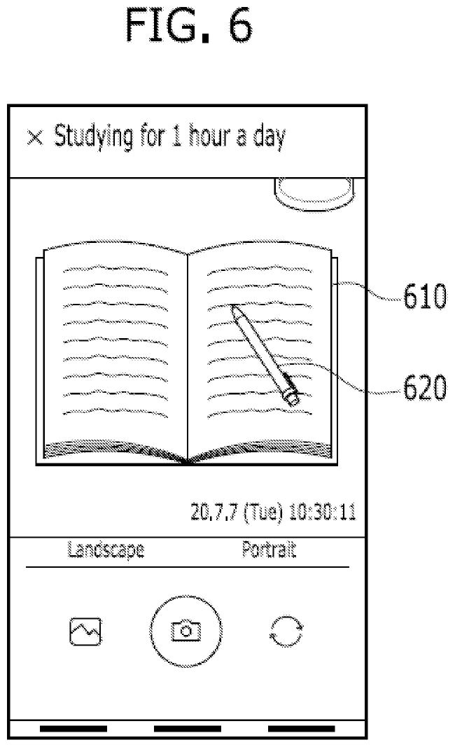

FIG. 6 is a diagram illustrating an example of determining whether or not the user performed a challenge, by determining whether or not an object associated with the challenge is included in an image according to an embodiment. According to an embodiment, the user may capture an image of himself performing a challenge that he is participating by using the camera of the user terminal. In this case, the user terminal may transmit the request to authenticate performance of a challenge including the information on user account, the information on a challenge he is participating, captured image(s), time information (time of capturing an image, time of transmitting an image, and the like), and the like to the goal achievement reward providing system.

In an embodiment, the goal achievement reward providing system (e.g., challenge performance determining module) may determine an object associated with the challenge based on the name of the challenge. For example, when the name of the challenge is “Study 1 hour a day”, documents including letters such as books, newspapers, and notes, writing instruments such as pens and pencils, and the like may be determined as the objects associated with the challenge. When the name of the challenge is “Drink water once a day”, the challenge performance determining module may determine a tumbler, a tea cup, a water glass, a water bottle, a bowl, and the like as the objects associated with the challenge. Alternatively or additionally, the objects associated with the challenge may be determined by the user account that created the challenge.

Then, the challenge performance determining module may use an object recognition model to determine whether or not the object associated with the challenge is included in the image(s) received from the user terminal, and determine the received image(s) as the authentication image(s) based on the result of determination, to determine whether or not the user performed the challenge on that date. In this example, the object recognition model may be a machine learning model that is trained to recognize and classify the objects included in the received image(s). According to an embodiment, when one or more of the object(s) recognized by the object recognition model is the object associated with the name of the challenge, the challenge performance determining module may determine that the challenge was performed, and store the image(s) as the authentication image(s). Alternatively or additionally, the type and number of objects required to be included in the received image to make the received image an authentication image, may be determined by the user.

For example, the challenge performance determining module may determine documents including letters such as books, newspapers, and notes, writing instruments such as pens and pencils, and the like as the objects associated with the challenge, based on “Study 1 hour a day”, which is the name of the challenge that the user account associated with the user terminal is participating. When receiving an image from the user terminal, the challenge performance determining module may recognize a book 610 and a ballpoint pen 620, which are the objects included in the received image, as illustrated through the object recognition model, and authenticate the image as the authentication image, and determine that the user account that transmitted the request to authenticate a challenge has performed the challenge on that date (on Jul. 7, 2020).

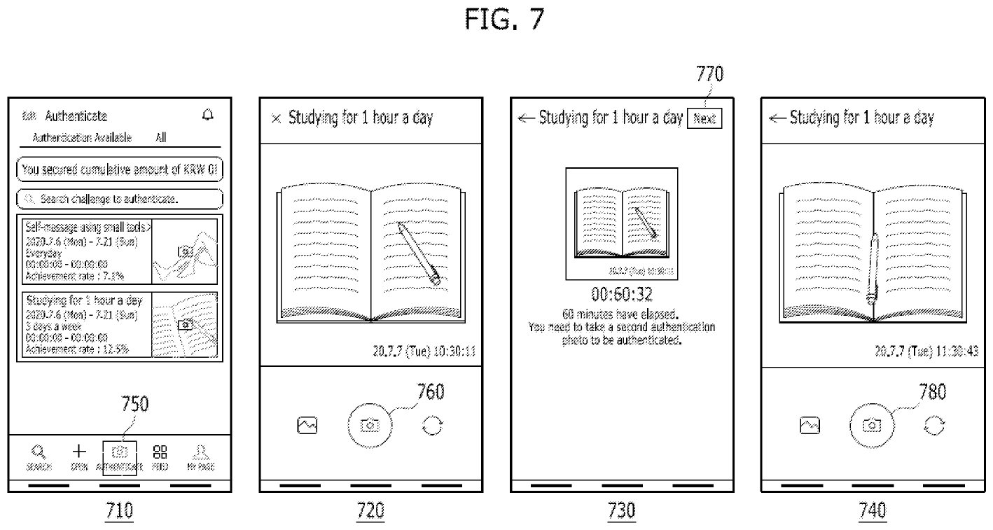

FIG. 7 is a diagram illustrating an example of authenticating performance of a challenge according to an embodiment. The user may use an application running on the user terminal to authenticate performance of the challenge that the user is participating, through first to fourth operations 710-740. The first operation 710 represents the user selecting one challenge to authenticate from a list of challenges that the user is participating.

According to an embodiment, in order to authenticate a challenge, the user may select an authentication button 750 to display on the screen the list of challenges that the user is participating. The list of challenges that the user is participating may include a name of each challenge (e.g., “Study 1 hour a day”), a period of time for performing a challenge (e.g., July 06/Mon-July/19/Sun), the number of days to perform the challenge (3 days per week), a time to perform the challenge (00:00:00-00:00:00, i.e., the challenge can be performed at any time of the day), a related image, an achievement rate (12.5%), whether or not performance of the challenge was authenticated today, and the like. The user may select one of the challenges displayed on the screen through a touch input or the like to move to a screen to authenticate performance of the challenge.

At this time, the goal achievement reward providing system (e.g., the challenge performance determining module) may provide the screen to authenticate performance of a challenge, based on a day of the week and a time of the day at which the authentication of performance of a challenge is available, which may be selected by the user. For example, when the challenge is “Study 1 hour on a weekend”, the challenge performance determining module may allow an in-app camera of an application to capture an image only on the weekend, which is the day of the week when the authentication of a performance of a challenge is available. During the days of the week or the time of the day when the authentication of performance of a challenge is not available, a message indicating that the authentication of performance of a challenge is not available may be displayed on the screen of the user terminal.

The second operation 720 represents that the screen to authenticate performance of a challenge is displayed on the display of the user terminal in response to the user selecting one challenge (“Study 1 hour a day” challenge). As illustrated, the screen to authenticate performance of a challenge may include a capturing button 760 for capturing an image associated with the challenge. The user may select the capturing button 760 through a touch input and the like to capture an image (first image) associated with the challenge to authenticate.

According to an embodiment, when it is required to continuously perform the challenge for a certain period of time to authenticate performance of a challenge, the challenge performance determining module may determine the time at which the captured image (first image) is received as a start time of authentication of a challenge. As illustrated, the start time (Tuesday, Jul. 7, 2020, 10:30:11) of authentication of a challenge may be displayed on the captured image (first image) to be provided to the user. In this example, when authentication of a challenge starts, the received image (the first image) may be recognized as the start time of authentication of a challenge when objects (e.g., a book, a ballpoint pen, and the like) associated with the challenge are included, as illustrated.

The third operation 730 represents that, in response to the start time of authentication of a challenge being recognized, a period of time to continuously perform a challenge is measured and displayed on the display of the user terminal. When a minimum period of time to continuously perform a challenge is required to authenticate performance of a challenge, the challenge performance determining module may measure the period of time to continuously perform a challenge from the start time of authentication of a challenge, and display the measured period of time to continuously perform a challenge on the display as illustrated. In this case, information on the minimum period of time to continuously perform a challenge (e.g., a message indicating “60 minutes have elapsed. You need to take a second authentication photo to be authenticated.”) may be displayed on the display together with the period of time during which the challenge was performed.

According to an embodiment, when authentication of a challenge starts, after the minimum period of time elapses from the time of receiving the captured image (first image), the challenge performance determining module may allow to capture an image (second image) for an end of performance of a challenge. For example, when the challenge is “Study 1 hour a day”, the minimum period of time required to authenticate performance of a challenge is “1 hour”, and the image (second image) for an end of performance of a challenge may be captured after 1 hour elapses from the start time of authentication of a challenge. After the minimum period of time elapses, the user may select a next button 770 through a touch input or the like to move to a screen for finishing authenticating a challenge. In an embodiment, after the minimum period of time elapses from the start time of authentication of a challenge, by a push message, the user may be given a message indicating that it is possible to take an image for an end of performance of a challenge.

The fourth operation 740 represents that, in response to the user selecting the next button 770, a screen for an end of the authentication of a challenge is displayed on the display of the user terminal. As illustrated, the screen for an end of the authentication of a challenge may include a capturing button 780 for capturing an image (second image) indicating the end of performance of a challenge. The user may select the capturing button 780 through a touch input and the like to capture an image (second image) associated with the challenge. In this example, the received image (the second image) may be recognized as an end time of authentication of a challenge when objects (e.g., a book, a ballpoint pen, and the like) associated with the challenge are included, as illustrated. According to an embodiment, when authentication of a challenge starts, the received image (first image) may be recognized as an authentication image, when the challenge performance determining module receives the image (second image) for an end of performance of a challenge after the minimum period of time elapses from the time of receiving the captured image (first image).

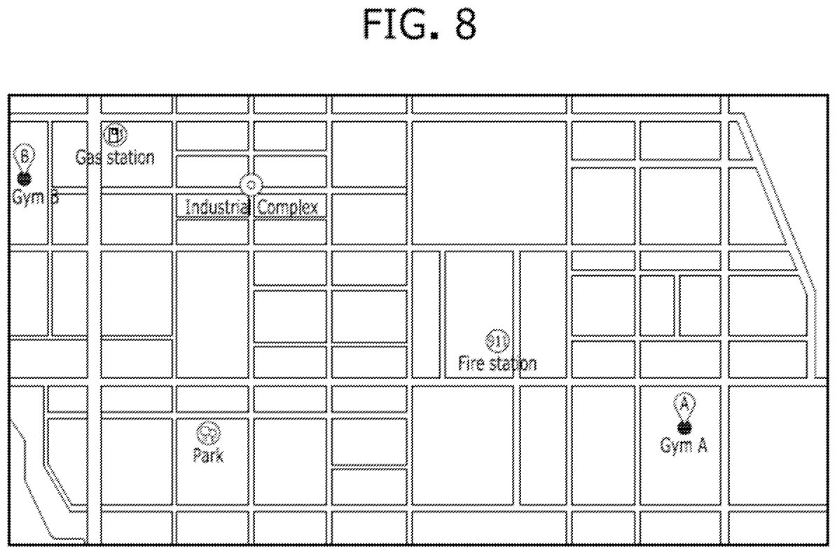

FIG. 8 is a diagram illustrating an example of determining whether or not a challenge has been performed based on position information according to an embodiment. According to an embodiment, when the position information is required for the authentication of a challenge, the request to authenticate performance of a challenge may include the position information associated with the captured image. The challenge performance determining module may compare the position information associated with the image included in the request to authenticate performance of a challenge, with the position information associated with the pre-authenticated authentication images, and determine the received image to be an authentication image based on the result of comparison.

According to an embodiment, when the challenge performance determining module determines that the position information associated with the image received from the user terminal has a difference of at least a predetermined threshold value from the position information associated with the pre-authenticated authentication images among a plurality of images received from the same user terminal, the challenge performance determining module may not recognize the received image as an authentication image. For example, when a user participating in the challenge of “Exercising everyday” has successfully authenticated that the user performed the challenge several times at “Gym A”, when the user captured an image to authenticate performance of a challenge at another location (e.g., “Gym B”) that is about 10 km away from “Gym A”, the challenge performance determining module may not recognize the received image as an authentication image and may determine that the user has not performed the challenge. In another example, the user may input a location (e.g., Gym A) to perform a challenge at the time of participating in the challenge, and when the user performs the challenge at another location (Gym B) that is distanced away from that location by a predetermined threshold value or more, it may be determined that the user has not performed the challenge. This is to prevent the user from stopping by at any gym and capturing an image for authentication, with a view to deceitfully authenticating performance of a challenge.

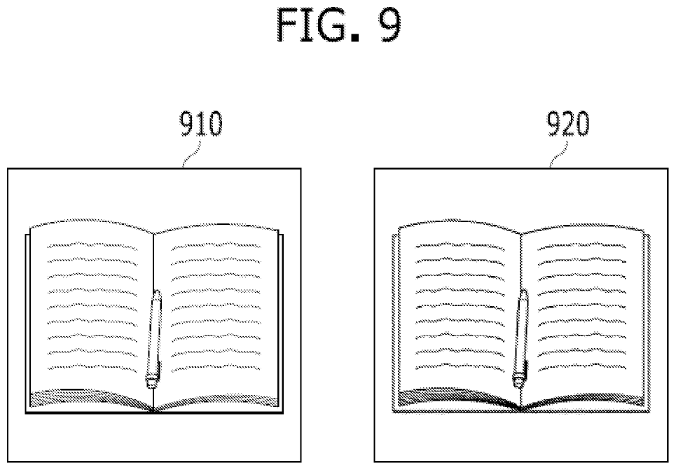

FIG. 9 is a diagram illustrating an example of determining whether or not a challenge has been performed according to an image quality of an image according to an embodiment. According to an embodiment, the challenge performance determining module may receive the request to authenticate performance of a challenge from the user terminal through the communication module. In this example, the request to authenticate performance of a challenge may include image(s) captured using the camera of the user terminal.

The challenge performance determining module may compare the image quality between the image(s) included in the request to authenticate performance of a challenge and authentication images previously authenticated by the same user, and determine the received image(s) to be an authentication image based on the result of comparison. According to an embodiment, when it is determined that the image received from the user terminal has an image quality difference of at least a predetermined threshold value from the pre-authenticated authentication images, the challenge performance determining module may not recognize the received image as an authentication image. For example, image(s) 910 recognized as the authentication image may have similar resolutions to each other and may be high-quality images having high resolution, since images of actual object associated with the challenge are captured through the camera of the user terminal when the challenge is performed. On the other hand, when the user re-captures a pre-captured image, a pre-printed image, or the like with the camera of the user terminal to forge authentication, the received image(s) 920 may be a low-quality image having a low resolution, as illustrated.

Accordingly, when it is determined that the received image has an image quality difference of at least a predetermined threshold value from the authentication images, the challenge performance determining module may not recognize the received image as an authentication image, and may determine that the challenge has not been performed. Additionally, when it is determined that there is an image quality difference between the received image and the authentication images, the challenge performance determining module may transmit a warning message or impose a penalty to a user account associated with the user terminal. Additionally or alternatively, when it is determined that there is an image quality difference between the received image and the authentication images, the challenge performance determining module may request the user terminal to capture an image again. In this way, by comparing the image quality between the received image and authentication images to detect an attempt to forge authentication, it is possible to prevent authentication forgery.

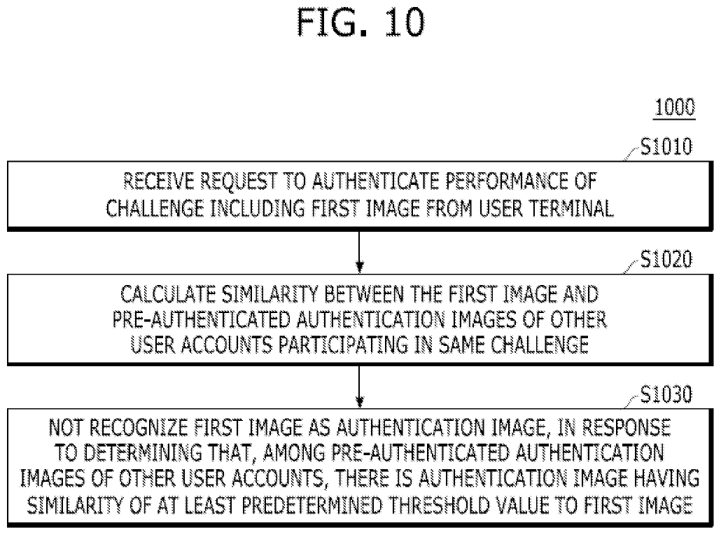

FIG. 10 is a flowchart illustrating a method 1000 for determining whether or not a challenge has been performed based on a similarity to authentication images of other users according to an embodiment. The method 1000 may be performed by the goal achievement reward providing system (e.g., one or more processors of the goal achievement reward providing system). As illustrated, the method 1000 may be initiated by the processor receiving a request to authenticate performance of a challenge including a first image from the user terminal, at S1010. In an embodiment, the request to authenticate performance of a challenge may further include a user account associated with the user terminal, information on a challenge for which authentication is to be performed, time information, and the like.

In response to receiving the request to authenticate performance of a challenge, the processor may calculate a similarity between the first image and the pre-authenticated authentication images of the other user accounts participating in the same challenge, at S1020. Then, in response to determining that, among the pre-authenticated authentication images of the other user accounts, there is an authentication image having a similarity of at least the predetermined threshold value (e.g., 90%) to the first image, the processor may not recognize the first image as an authentication image, at S1030. That is, when the first image has a similarity of less than the predetermined threshold value to the pre-authenticated authentication images of the other user accounts, the processor may recognize the first image as an authentication image. In this case, by referring to the authentication image of another user account that has a similarity of at least the predetermined threshold value to the first image (e.g., by referring to an authentication image that has a similarity of 95% to the first image), the challenge performance determining module may transmit the first image to the user terminal together with a message asking to change an image capturing angle and capture an image again. According to another embodiment, when having not determined the first image to be an authentication image, the challenge performance determining module may transmit a warning message or impose a penalty to a user account associated with the user terminal.

While FIG. 10 illustrates that the processor determines whether or not a challenge has been performed based on the similarity to the authenticated authentication image of the other user accounts participating in the same challenge, the present disclosure is not limited thereto. For example, the processor may use not only the pre-authenticated authentication images of the other user accounts participating in the same challenge, but also the pre-authenticated authentication images of the user accounts participating in the same or similar challenges currently in progress, and the pre-authenticated authentication images of the user accounts participating in the same or similar challenges in the past. Additionally or alternatively, the processor may also use the pre-authenticated images of the user account associated with the user terminal that transmitted the request to authenticate performance of a challenge. With this configuration, it is possible to prevent the same user from receiving rewards redundantly by multiple accounts using a single photo or from receiving rewards redundantly using a photo used in the past.

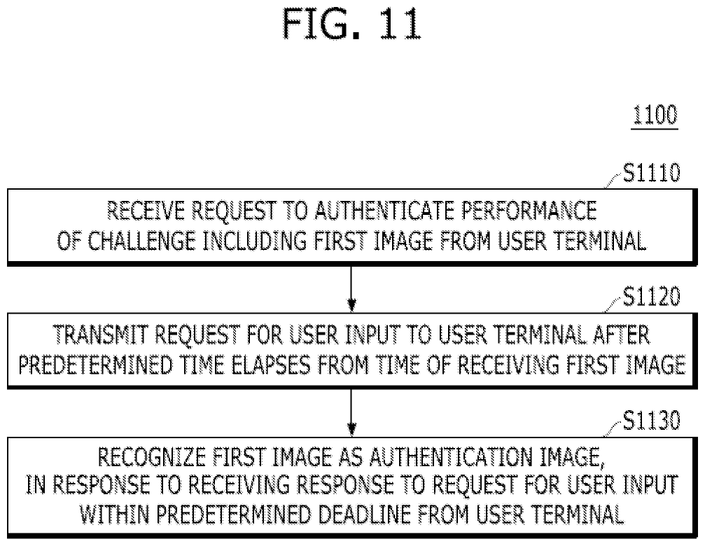

FIG. 11 is a flowchart illustrating a method 1100 for authenticating whether or not a challenge specialized for a wake-up mission was performed according to an embodiment. The method 1100 may be performed by the goal achievement reward providing system (e.g., one or more processors of the goal achievement reward providing system). As illustrated, the method 1100 may be initiated by the processor receiving a request to authenticate performance of a challenge including a first image from the user terminal, at S1110. In an embodiment, the request to authenticate performance of a challenge may further include a user account associated with the user terminal, information on a challenge for which authentication is to be performed, time information, and the like. For example, when the challenge that the user wants to authenticate is “Wake up at 7 a.m.”, the user may capture an image associated with the challenge using the camera of the user terminal before 7 a.m. and transmit the same to the goal achievement reward providing system. In this case, the application running on the user terminal may allow the in-app camera to capture an image only before 7 a.m.

In response to receiving the request to authenticate performance of a challenge, the processor may transmit a request for a user input to the user terminal after a predetermined time elapses from the time of receiving the first image from the user terminal, at S1120. In another embodiment, the processor may transmit the request for a user input to the user terminal after any time less than a predetermined time (e.g., 30 minutes) elapses from the time of receiving the first image. For example, the processor may transmit a wake-up mission to the user terminal at 7:10 a.m., after 10 minutes elapses from 7 a.m. The request for a user input may be a message that requests the user to perform a predetermined action (capturing a picture, answering a simple quiz, inputting a drag according to a pattern displayed on the screen, and the like).

Thereafter, at S1130, in response to receiving a response to the request for a user input within a predetermined deadline (e.g., within 10 minutes) from the user terminal, the first image may be recognized as an authentication image. For example, in response to the user performing a predetermined action using an interface provided on the screen of the user terminal within 10 minutes from 7:10 a.m., i.e., within 10 minutes from the time when the user received the request for a user input, the challenge performance determining module of the processor may recognize the received first image as an authentication image. With the configuration as described above, by requiring the user to perform one or more missions after the user uploads the image associated with the challenge, a method of authentication specific to a wake-up mission may be provided, which does not recognize that the challenge is performed on that date when the user captures an image and then falls back asleep.

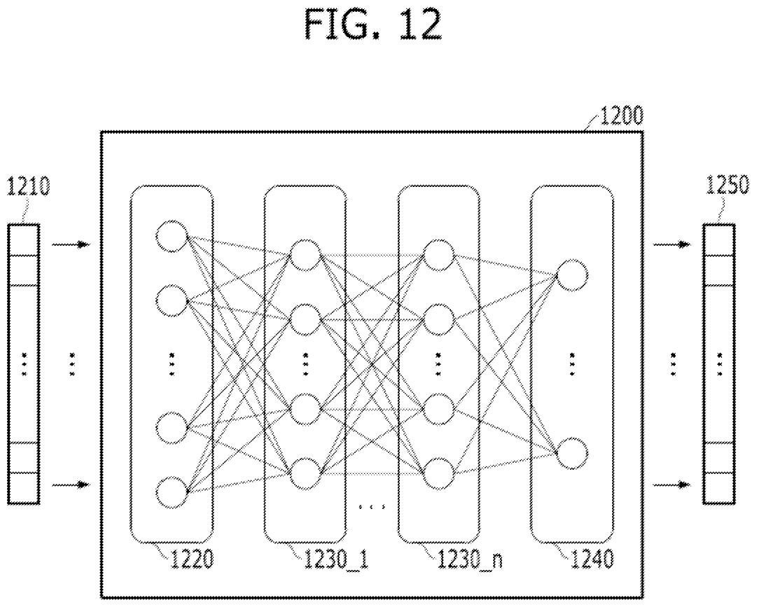

FIG. 12 is a structural diagram illustrating an artificial neural network 1200 according to an embodiment. In machine learning technology and cognitive science, the artificial neural network 1200 refers to a statistical training algorithm implemented based on a structure of a biological neural network, or to a structure that executes such algorithm. That is, the artificial neural network 1200 represents a machine learning model that acquires a problem solving ability by repeatedly adjusting the weights of synapses by the nodes that are artificial neurons forming the network through synaptic combinations as in the biological neural networks, thus training to reduce errors between a target output corresponding to a specific input and a deduced output. For example, the object recognition model described above may be this machine learning model. In general, the artificial neural network is implemented as a multilayer perceptron (MLP) formed of multiple nodes and connections between them. The artificial neural network 1200 according to the present embodiment may be implemented using one of various artificial neural network structures including the MLP. The artificial neural network 1200 includes an input layer 1220 that receives an input signal or data 1210 from the outside, an output layer 1240 that outputs an output signal or data 1250 corresponding to the input data, and (n) number of hidden layers 1230_1 to 1230_n positioned between the input layer 1220 and the output layer 1240 to receive a signal from the input layer 1220, extract the features, and transmit the features to the output layer 1240. Here, the output layer 1240 receives signals from the hidden layers 1230_1 to 1230_n and outputs them to the outside. In general, the training method of the artificial neural network 1200 includes a supervised learning that trains for optimization for solving a problem with inputs of teacher signals (correct answer), and an unsupervised learning that does not require a teacher signal. The goal achievement reward providing method and system according to the present disclosure may train the artificial neural network 1200 to recognize and classify objects included in images by using supervised learning, unsupervised learning, and semi-supervised learning. The artificial neural network 1200 trained in this way may extract an object included in an image received from the user terminal. In an embodiment, as illustrated in FIG. 12, the input variable of the artificial neural network 1200 may be an image vector 1210 in which an image received from a user terminal is composed of one vector data element. Meanwhile, an output variable output from the output layer 1240 of the artificial neural network 1200 may be a vector 1250 representing the type of object included in the image. In the present disclosure, the output variable of the artificial neural network 1200 may not be limited to the types described above. As described above, the input layer 1220 and the output layer 1240 of the artificial neural network 1200 are respectively matched with a plurality of output variables corresponding to a plurality of input variables, so as to adjust the synaptic values between nodes included in the input layer 1220, the hidden layers 1230_1 to 1230_n, and the output layer 1240, thereby enabling training to infer the correct output corresponding to a specific input. Through this training process, the features hidden in the input variables of the artificial neural network 1200 may be confirmed, and the synaptic values (or weights) between the nodes of the artificial neural network 1200 may be adjusted so as to reduce the errors between the output variable calculated based on the input variable and the target output. Using the artificial neural network 1200 trained in this way, an object included in the image received from the user terminal may be extracted.

The methods for authenticating performance of a challenge described above may be performed individually or together. Further, in addition to the methods for authenticating performance of a challenge described above, various authentication methods may be used. For example, if the time obtained from the goal achievement reward providing system and the time obtained based on the position information received from the user terminal do not match each other, an alarm may be transmitted to the goal achievement reward providing system, and a warning message may be transmitted or a penalty may be given to the user account associated with the user terminal. Accordingly, it is possible to prevent forgery of authentication by forging the time associated with the request to authenticate a challenge, such as challenge authentication time, challenge performing time, and the like by arbitrarily adjusting the time of the user terminal.

For example, when the user captures an image through the in-app camera of the application running on the user terminal, the in-app camera may be automatically shut down when the image is not captured even after a preset time (e.g., 20 seconds) elapses. Accordingly, it is possible to prevent a user from turning on the camera in advance for the purpose of challenge authentication and authenticating a challenge.

For example, when the position information is required to authenticate a challenge, the goal achievement reward providing system may receive the position information from the user terminal. In response to determining that the user stays at a place (e.g., a gym) related to the challenge (e.g., exercise once a day) for a preset time (e.g., 4 hours) or longer based on the position information received from the user, the goal achievement reward providing system may cancel the payment of the challenge such that the user account of the user terminal cannot participate in the challenge. As a result, it is possible to prevent users with specific occupations (e.g., fitness trainers) from participating in challenges related to that occupation (such as exercise once a day) to fraudulently receive prize money by authenticating that challenge.

The goal achievement reward providing method described above may be implemented as a computer-readable code on a computer-readable recording medium. The computer-readable recording medium includes all kinds of recording devices in which data readable by a computer system is stored. Examples of computer readable recording medium include ROM, RAM, CD-ROM, magnetic tape, floppy disks, and optical data storage devices, and the like. In addition, the computer readable recording medium may be distributed over network coupled computer systems so that the computer readable code is stored and executed in a distributed manner. Further, programmers in the technical field pertinent to the present disclosure will be easily able to envision functional programs, codes and code segments to implement the embodiments.

The methods, operations, or techniques of this disclosure may be implemented by various means. For example, these techniques may be implemented in hardware, firmware, software, or a combination thereof. Those skilled in the art will further appreciate that the various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the disclosure, computer, or a combination thereof.

Accordingly, various example logic blocks, modules, and circuits described in connection with the disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transfer of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that can be used to transfer or store desired program code in the form of instructions or data structures and can be accessed by a computer. Also, any connection is properly referred to as a computer-readable medium.

For example, when the software is transmitted from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in, RAM memory, flash memory, ROM memory, EPROM memory, EEPROM memory, registers, hard disk, removable disk, CD-ROM, or any other form of storage medium known. An exemplary storage medium may be connected to the processor, such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the embodiments described above have been described as utilizing aspects of the currently disclosed subject matter in one or more standalone computer systems, the present disclosure is not limited thereto, and may be implemented in conjunction with any computing environment, such as a network or distributed computing environment. Furthermore, aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some embodiments herein, various modifications and changes can be made without departing from the scope of the present disclosure, which can be understood by those skilled in the art to which the present disclosure pertains. Further, such modifications and changes are intended to fall within the scope of the claims appended herein.

What is claimed is:

1. A method for providing a goal achievement reward, performed by one or more processors, the method comprising:
receiving, from a user terminal, a request to participate in a challenge;
receiving, from the user terminal, a request to pay a participation fee for the challenge;
receiving, from the user terminal, a plurality of images associated with the challenge;
calculating a percentage of challenge achievement of a first user account associated with the user terminal based on the plurality of images; and
providing a reward to the user terminal based on the calculated percentage of challenge achievement.

2. The method according to claim 1, wherein the providing a reward to the user terminal includes:
in response to determining that the percentage of challenge achievement is 100%, providing the participation fee and additional prize money to the user terminal as a reward;
in response to determining that the percentage of challenge achievement is equal to or greater than a preset threshold value and less than 100%, providing the challenge participation fee to the user terminal as a reward; and
in response to determining that the percentage of challenge achievement is less than a preset threshold value, providing a portion of the challenge participation fee to the user terminal as a reward,
wherein the additional prize money is determined based on non-refundable amounts of user accounts having a percentage of challenge achievement less than the preset threshold value, among a plurality of other user accounts participating in the challenge.

3. The method according to claim 1, further comprising:
receiving identification information of the user terminal;
storing the identification information of the user terminal in association with the first user account; and
in response to detecting an attempt to access using a second user account from the user terminal, transmitting a warning message to the user terminal.

4. The method according to claim 1, wherein
the plurality of images includes a first image, and
the calculating a percentage of challenge achievement includes:
determining an object associated with the challenge based on a name of the challenge;
determining whether the object associated with the challenge is included in the first image using an object recognition model; and
in response to determining that the object associated with the challenge is included in the first image, recognizing the first image as an authentication image.

5. The method according to claim 1, wherein the plurality of images includes a first image and a second image including the object associated with the challenge, and
the calculating a percentage of challenge achievement includes:
in response to receiving the second image after a predetermined period of time elapses from a time of receiving the first image, recognizing the first image as an authentication image.

6. The method according to claim 1, wherein
the plurality of images includes a first image, and
the calculating a percentage of challenge achievement includes:
in response to determining that position information associated with the first image has a difference equal to or greater than a predetermined threshold value from position information associated with pre-authenticated authentication images among the plurality of images, denying authentication of the first image.

7. The method according to claim 1, wherein
the plurality of images includes a first image, and
the calculating a percentage of challenge achievement includes:
comparing image quality between the first image and pre-authenticated authentication images among the plurality of images; and
in response to determining that the first image has an image quality difference equal to or greater than a predetermined threshold value from the pre-authenticated authentication images, denying authentication of the first image.

8. The method according to claim 1, wherein
the plurality of images includes a first image, and
the calculating a percentage of challenge achievement includes:
calculating a similarity between the first image and pre-authenticated authentication images of other user accounts participating in the challenge; and
in response to determining that, among the pre-authenticated authentication images of the other user accounts, there is an authentication image having a similarity equal to or greater than a predetermined threshold value to the first image, denying authentication of the first image.

9. The method according to claim 8, further comprising:
transmitting, to the user terminal, the authentication image of another user account having a similarity equal to or greater than the predetermined threshold value to the first image; and
transmitting, to the user terminal, a message to change an image capturing angle and capture the first image again by referring to the authentication image of the other user account.

10. The method according to claim 1, wherein
the plurality of images includes a first image, and
the calculating a percentage of challenge achievement includes:
transmitting, to the user terminal, a request for a user input after a predetermined time elapses from a time of receiving the first image; and
in response to receiving, from the user terminal, a response to the request for a user input within a predetermined deadline, recognizing the first image as an authentication image.
